(19) United States
(12) Patent Application Publication
(10) Pub. No.: US 2011/0125497 A1
(43) Pub. Date: May 26, 2011

(54) Method and System for Voice Activity Detection

(76) Inventor: Takahiro Unno, Richardson, TX (US)

(21) Appl. No.: 12/945,727

(22) Filed: Nov. 12, 2010

Related U.S. Application Data
(60) Provisional application No. 61/263,198, filed on Nov. 20, 2009.

(51) Int. Cl. G10L 15/20

(52) U.S. Cl. 704/233; 704/E15.001

(57) ABSTRACT

A method of voice activity detection is provided that includes measuring a first signal level in a first sample of a first audio signal from a first audio capture device and a second signal level in a second sample of a second audio signal from a second audio capture device, and detecting voice activity based on the first signal level, the second signal level, and an activity threshold.

### CROSS-REFERENCE TO RELATED APPLICATIONS

This application claims benefit of U.S. Provisional Patent Application Ser. No. 61/263,198, filed Nov. 20, 2009, which is incorporated herein by reference in its entirety.

### BACKGROUND OF THE INVENTION

Voice activity detection (VAD), which is also referred to as speech activity detection or speech detection, determines the presence or absence of human speech in audio signals which may also contain music, noise, or other sound. VAD is widely used in speech signal processing such as noise cancellation, echo cancellation, automatic speech level control, and speech coding. Known techniques for VAD are designed to operate using a single audio signal captured from a single microphone. One of the more efficient techniques for VAD is described in U.S. Pat. No. 7,577,248 entitled “Method and Apparatus for Echo Cancellation, Digit Filter Adaptation, Automatic Gain Control and Echo Suppression Utilizing Block Least Mean Squares,” and filed on Jun. 24, 2005. This technique is reliable and computationally efficient in the presence of quiet or stationary background noise, but may be less reliable and computationally efficient in the presence of non-stationary background noise that includes voice(s) other than the desired voice, music, and/or other cluttering sounds. Accordingly, improvements in VAD are desirable.

### BRIEF DESCRIPTION OF THE DRAWINGS

Particular embodiments in accordance with the invention will now be described, by way of example only, and with reference to the accompanying drawings:

FIG. 1 shows a block diagram of a digital system in accordance with one or more embodiments of the invention;

FIG. 2 shows a block diagram of an audio encoder in accordance with one or more embodiments of the invention;

FIGS. 3-5 show flow diagrams of methods in accordance with one or more embodiments of the invention;

FIG. 6 shows example microphone configurations in accordance with one or more embodiments of the invention; and

FIG. 7 shows an illustrative digital system in accordance with one or more embodiments of the invention.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

Certain terms are used throughout the following description and the claims to refer to particular system components. As one skilled in the art will appreciate, components in digital systems may be referred to by different names and/or may be combined in ways not shown herein without departing from the described functionality. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” and derivatives thereof are intended to mean an indirect, direct, optical, and/or wireless electrical connection. Thus, if a first device couples to a second device, that connection may be through a direct electrical connection, through an indirect electrical connection via other devices and connections, through an optical electrical connection, and/or through a wireless electrical connection.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. In addition, although method steps may be presented and described herein in a sequential fashion, one or more of the steps shown and described may be omitted, repeated, performed concurrently, and/or performed in a different order than the order shown in the figures and/or described herein.

In general, embodiments of the invention provide for voice activity detection (VAD) in an audio signal captured using at least two microphones. More specifically, in embodiments of the invention, audio signals possibly including speech, i.e., voice, and other audio content, e.g., interference, are captured using two or more microphones, and VAD as described herein is performed using the captured signals from the two or more microphones to detect whether or not speech, i.e., voice activity, is present. Interference may be any audio content in an audio signal other than the desired speech. For example, when a person is speaking on a cellular telephone, the audio signal includes that person's speech (the desired speech) and other sounds from the environment around that person, e.g., road noise in a moving automobile, wind noise, one or more other people speaking, music, etc. that interfere with the speech. In one or more embodiments of the invention, the two or more microphones are positioned such that the signal level of the voice of a speaker is higher at one microphone, i.e., the primary microphone, than at the other microphone(s), i.e., the secondary microphone(s). The difference in the signal levels between the signal from the primary microphone and the signal(s) from the secondary microphone(s) is computed. The level difference or differences are then used to determine if voice activity is present.

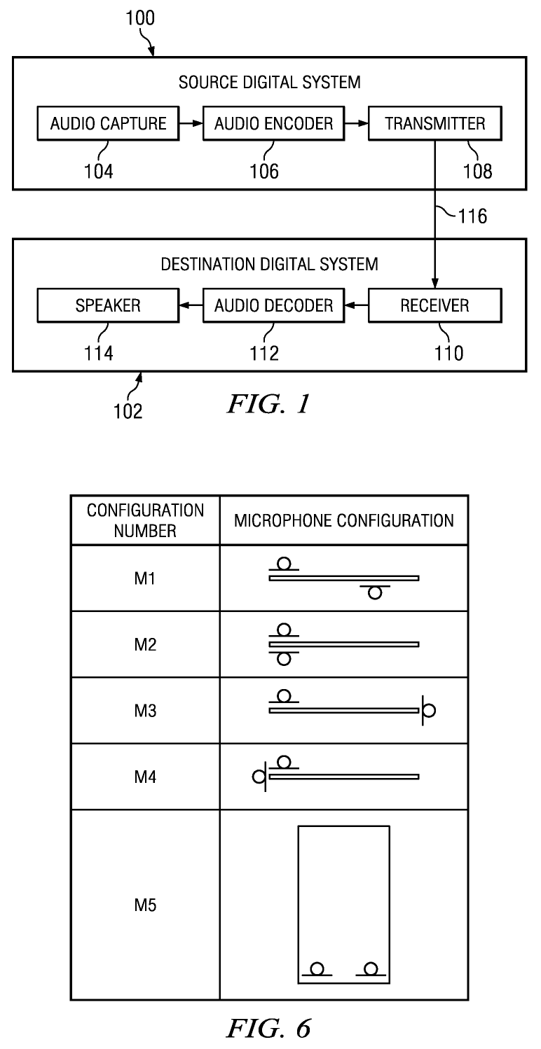

FIG. 1 shows a block diagram of a system in accordance with one or more embodiments of the invention. The system includes a source digital system (100) that transmits encoded digital audio signals to a destination digital system (102) via a communication channel (116). The source digital system (100) includes an audio capture component (104), an audio encoder component (106), and a transmitter component (108). The audio capture component (104) includes functionality to capture two or more audio signals. In some embodiments of the invention, the audio capture component (104) also includes functionality to convert the captured audio signals to digital audio signals. The audio capture component (104) also includes functionality to provide the captured analog or digital audio signals to the audio encoder component (106) for further processing. The audio capture component (104) may include two or more audio capture devices, e.g., analog microphones, digital microphones, microphone arrays, etc. The audio capture devices may be arranged such that the captured audio signals each include a mixture of speech content (when a person is speaking) and other audio content, e.g., interference.

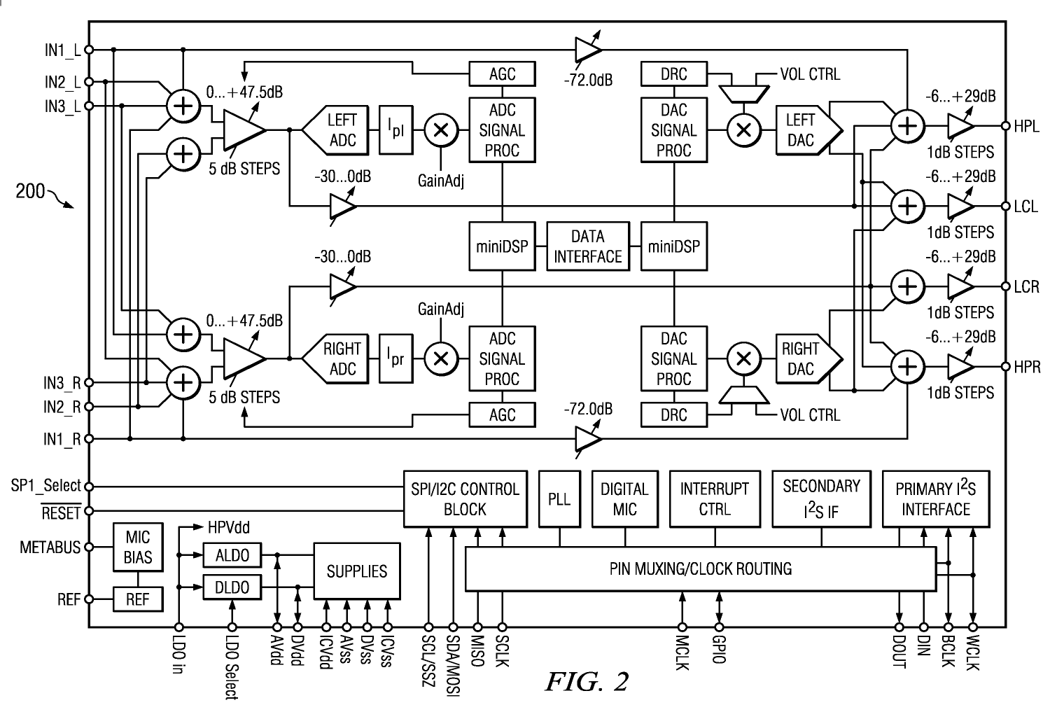

The audio encoder component (106) includes functionality to receive the two or more audio signals from the audio capture component (104) and to process the audio signals for transmission by the transmitter component (108). In some embodiments of the invention, the processing includes converting analog audio signals to digital audio signals when the received audio signals are analog. The processing also includes encoding the digital audio signals for transmission in accordance with an encoding standard. The processing further includes performing a method for VAD in accordance with one or more of the embodiments described herein. More specifically, a method for VAD is performed that takes the two or more digital audio signals as input and determines whether or not voice activity is present. This determination may then be used by the audio encoder component (106) to guide further processing of the audio signals. Ultimately, the audio encoder component (106) generates an encoded output audio signal that is provided to the transmitter component (108). The functionality of an embodiment of the audio encoder component (106) is described in more detail below in reference to FIG. 2.

The transmitter component (108) includes functionality to transmit the encoded audio data to the destination digital system (102) via the communication channel (116). The communication channel (116) may be any communication medium, or combination of communication media suitable for transmission of the encoded audio sequence, such as, for example, wired or wireless communication media, a local area network, and/or a wide area network.

The destination digital system (102) includes a receiver component (110), an audio decoder component (112) and a speaker component (114). The receiver component (110) includes functionality to receive the encoded audio data from the source digital system (100) via the communication channel (116) and to provide the encoded audio data to the audio decoder component (112) for decoding. In general, the audio decoder component (112) reverses the encoding process performed by the audio encoder component (106) to reconstruct the audio data. The reconstructed audio data may then be reproduced by the speaker component (114). The speaker component (114) may be any suitable audio reproduction device.

In some embodiments of the invention, the source digital system (100) may also include a receiver component and an audio decoder component, and a speaker component and/or the destination digital system (102) may include a transmitter component, an audio capture component, and an audio encoder component for transmission of audio sequences in both directions. Further, the audio encoder component (106) and the audio decoder component (112) may perform encoding and decoding in accordance with one or more audio compression standards. The audio encoder component (106) and the audio decoder component (112) may be implemented in any suitable combination of software, firmware, and hardware, such as, for example, one or more digital signal processors (DSPs), microprocessors, discrete logic, application specific integrated circuits (ASICs), field-programmable gate arrays (FPGAs), etc. Software implementing all or part of the audio encoder and/or audio decoder may be stored in a memory, e.g., internal and/or external ROM and/or RAM, and executed by a suitable instruction execution system, e.g., a microprocessor or DSP. Analog-to-digital converters and digital-to-analog converters may provide coupling to the real world, modulators and demodulators (plus antennas for air interfaces) may provide coupling for transmission waveforms, and packetizers may be included to provide formats for transmission.

FIG. 2 shows a block diagram of an audio encoder (200) (e.g., the audio encoder (106) of FIG. 1) in accordance with one or more embodiments of the invention. More specifically, FIG. 2 shows a simplified block diagram of a low power stereo audio codec available from Texas Instruments, Inc. This audio encoder is presented as an example of one audio encoder that may be configured to execute a method for VAD as described herein.

The audio encoder (200) include circuitry to accept inputs from two analog microphones and/or inputs from two digital microphones, ADC (analog-to-digital converter) circuitry for each analog input, and DAC (digital-to-analog converter) circuitry. The audio encoder (200) further includes a dual-core mini-DSP that may be used to perform interference cancellation techniques on the audio signals received from the digital and/or analog microphones as well as encoding audio signals. More specifically, the mini-DSP may be used to execute software implementing a method for VAD in accordance with one or more of the embodiments described herein. This software may be loaded into the device after power-up of a digital system incorporating the device. The functionality of the components of the audio encoder (200) will be apparent to one of ordinary skill in the art. Additional information regarding the functionality of this codec may be found in the product data sheet entitled “TLV320AIC3254, Ultra Low Power Stereo Audio Codec With Embedded miniDSP,” available at http://focus.ti.com/lit/ds/symlink/tlv320aic3254.pdf. The data sheet is incorporated by reference herein.

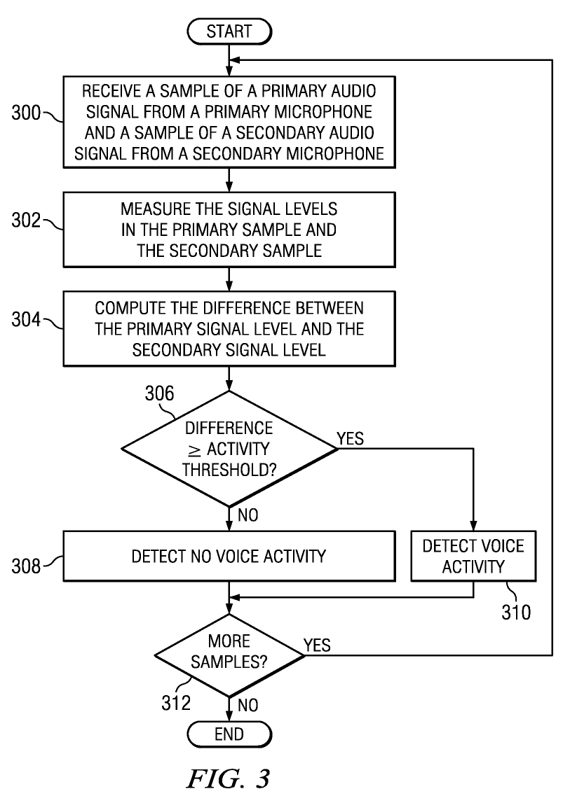

FIGS. 3-5 show flow diagrams of methods for VAD in accordance with one or more embodiments of the invention. For simplicity of explanation, the methods are described assuming audio inputs from two microphones. However, one of ordinary skill in the art will understand other embodiments in which more than two audio capture devices may be used. For example, if more than two microphones are used, the signal levels from each of the microphone may be determined and compared. The two signals that have the largest signal level difference may then be selected for determining whether voice activity is present as described herein. Further, the methods assume that each sample in the two input audio streams is processed. One of ordinary skill in the art will understand other embodiments in which samples are selected for processing periodically.

Referring now to FIG. 3, initially, a sample of primary audio signal, i.e., a primary sample, is received from a primary microphone and a sample of a secondary audio signal, i.e., a secondary sample, is received from a secondary microphone (300). The primary microphone and the secondary microphone may be embodied in a digital system (e.g., a cellular telephone, a speakerphone, an answering machine, a voice recorder, a computer system providing VOIP (Voice over Internet Protocol) communication, etc.) and are arranged to capture the speech of a person speaking, and any other sound in the environment where the speech is generated, i.e., interference. Thus, when the person is speaking, the primary audio signal and the secondary audio signal are a mixture of an audio signal with speech content and audio signals from other sounds in the environment. And, when the person is not speaking, the primary and secondary audio signals are mixtures of other sounds in the environment of the person speaking. In one or more embodiments of the invention, the primary microphone and the secondary microphone are arranged so as to provide diversity between the primary audio signal and the secondary audio signal, with the primary microphone closest to the mouth of the speaker. For example, in a cellular telephone, the primary microphone may be the microphone positioned to capture the voice of the person using the cellular telephone and the secondary microphone may be a separate microphone located in the body of the cellular telephone.

The signal levels in the primary sample and the secondary sample are then measured to determine a primary signal level and a secondary signal level (302). The signal levels may be measured using any suitable signal level measurement technique. In one or more embodiments of the invention, the signal levels are measured with smoothing. Smoothing is used because the signal power computed from a single input sample may have a large level fluctuation which could cause voice activity detection to excessively switch between detected and not detected. Experimental results show that the use of smoothing helps reduce excessive switching. Any suitable signal level measurement technique with smoothing may be used, such as, for example, moving average, autoregressive, binomial, Savitzky-Golay, etc. In one or more embodiments of the invention, first order autoregressive (AR) smoothing is applied in determining the signal levels as per the following equation:

Pᵢ(n)=α·Pᵢ(n−1)+(1−α)·sᵢ²(n),i=1,2 (1)

where i is the microphone index, Pᵢ(n) is a signal level at microphone i and sample n, sᵢ(n) is a audio signal at microphone i and sample n, and a controls the strength of the smoothing. The value of α may be any suitable value and may be empirically determined. The closer the value of α is to 1, the stronger the smoothing. In some embodiments of the invention, the value of α is exp(−1/Fₛ·0.02) where Fₛ is the sampling rate. Note that if the value of α is 0, the result of the equation is the instantaneous signal level in the sample n.

The difference between the primary signal level and the secondary signal level is then computed (304). Any suitable technique for computing this difference may be used. In one or more embodiments of the invention, the voice activity level difference D is computed in dB scale as per the following equation:

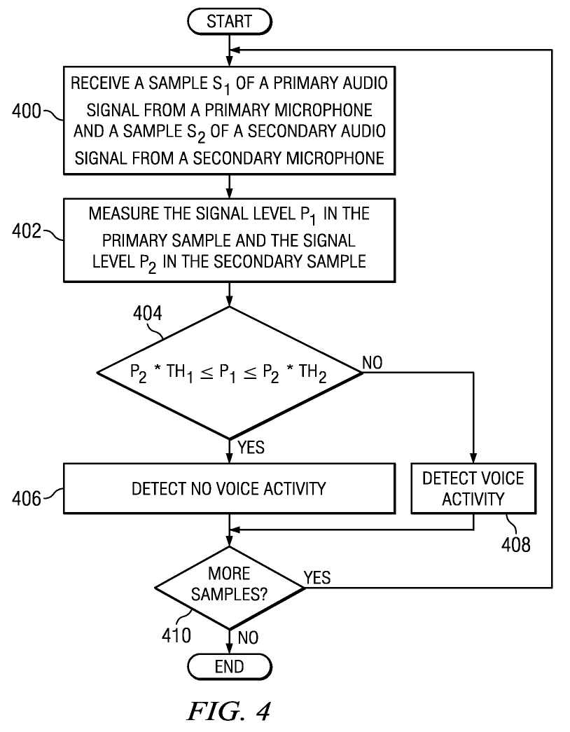

D=|10·log₁₀(P₁)−10·log₁₀(P₂)| (2)

where P₁ is the primary signal level and P₂ is the secondary signal level. In some embodiments of the invention, the voice activity level difference D may be computed as |P₁-P₂|. Experiments have shown that Eq. 2, while more computationally complex, is more reliable for a wide range of voice signals than computing the simple difference. The simple difference may not work well for low signal levels. As is described herein in reference to FIG. 4, Eq. 2 may be re-formulated for simpler computation.

The computed voice activity level difference D is then compared to an activity threshold TH (306). In one or more embodiments of the invention, the activity threshold is empirically determined. If the voice activity level difference is greater than or equal to the activity threshold, then voice activity is detected (310). Otherwise, voice activity is not detected (308). The method is then repeated if there are more samples (312). One of ordinary skill in the art will understand other embodiments of the invention in which the level comparison to the activity threshold may be greater than, less than or equal, or less than.

In some embodiments of the invention, the activity threshold TH may be different depending on the mode of operation of a device incorporating the method. For example, in one or more embodiments of the invention, the activity threshold is 9 dB for a cellular telephone used in handset mode, and 1.5 dB for a cellular telephone used in speaker phone mode. The activity threshold TH may also be different depending on the locations of the microphones. For example, for the handset mode, the threshold may range from 3 dB to 10 dB, and for the speaker phone mode, the threshold may range from 0 dB to 3 dB depending on microphone locations.

FIG. 4 shows a simplified version of the method of FIG. 3 in which the direct computation of the voice activity level difference is eliminated. The first two steps of the method of FIG. 4, 400 and 402, are the same as steps 300 and 302 of the method of FIG. 3. If the primary signal level P₁ falls within a range bounded by values computed based on the secondary signal level P₂ and the activity threshold TH (404), then no voice activity is detected (406). Otherwise, voice activity is detected (408). The method is then repeated if there are more samples (410). The lower bound of the range is computed as P₂·TH1 where TH1=10^{-0.1·TH}, and the upper bound of the range is computed as P₂·TH2 where TH2=10^{-0.1·TH}. One of ordinary skill in the art will understand other embodiments of the invention in which the range comparisons may be other than less than or equal to.

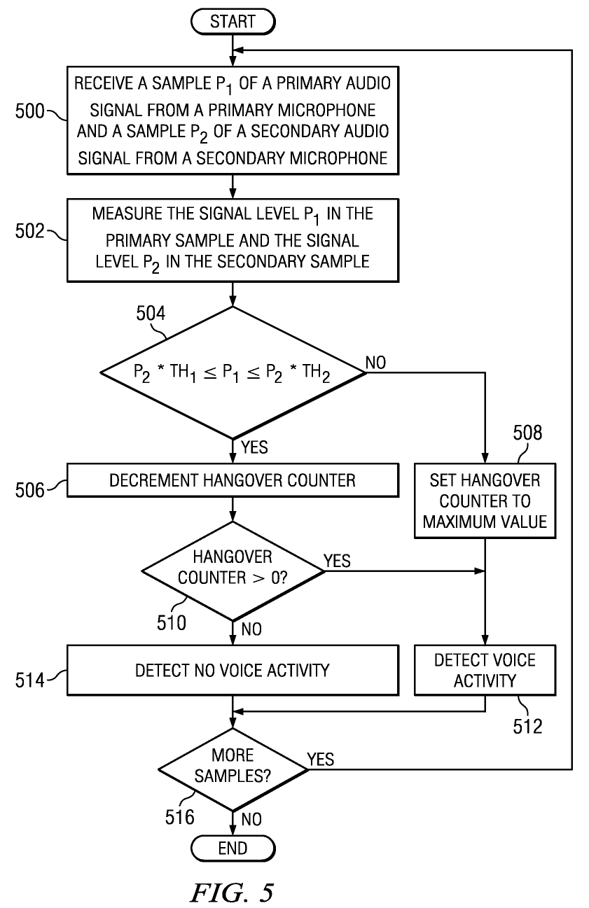

FIG. 5 shows the method of FIG. 4 with the addition of a hangover counter. The hangover counter is added to allow voice activity to remain detected when there are short pauses in the flow of speech, e.g., the speaker takes a breath. The first two steps of FIG. 5, 500 and 502, are the same as steps 300 and 302, 400 and 402, of the methods of FIG. 3 and FIG. 4, respectively. If the primary signal level P₁ falls within a range bounded by values computed based on the secondary signal level P₂ and the activity threshold TH (504), the hangover counter is decremented (506). If the hangover counter is not greater than 0 (510), then no voice activity is detected (514). Otherwise, voice activity is detected (512). The method is then repeated if there are more samples (516). If the primary signal level P₁ does not fall within the range, then the hangover counter is set to a maximum value (508), and voice activity is detected (512). The method is then repeated if there are more samples (516). The maximum value of the hangover counter may be empirically determined and controls how long a short pause in the speech flow may be before voice activity will no longer be detected. In one or more embodiments of the invention, the maximum value is 0.2*Fₛ where Fₛ is the sample rate. One of ordinary skill in the art will understand other embodiments of the invention in which the hangover counter counts up to the maximum value rather than counting down. One of ordinary skill in the art will also understand embodiments of the method of FIG. 3 with the addition of a hangover counter.

Embodiments of the methods for VAD and audio encoders described herein may be implemented in hardware, software, firmware, or any combination thereof. If implemented in software, the software may be executed in one or more processors, such as a microprocessor, application specific integrated circuit (ASIC), field programmable gate array (FPGA), or digital signal processor (DSP). Any included software may be initially stored in a computer-readable medium such as a compact disc (CD), a diskette, a tape, a file, memory, or any other computer readable storage device and loaded and executed in the processor. In some cases, the software may also be sold in a computer program product, which includes the computer-readable medium and packaging materials for the computer-readable medium. In some cases, the software instructions may be distributed via removable computer readable media (e.g., floppy disk, optical disk, flash memory, USB key), via a transmission path from computer readable media on another digital system, etc.

Further, embodiments of the methods for VAD and audio encoders described herein may be implemented for virtually any type of digital system with functionality to capture at least two audio signals (e.g., a desk top computer, a laptop computer, a handheld device such as a mobile (i.e., cellular) telephone, a personal digital assistant, a Voice over Internet Protocol (VOIP) communication device such as a telephone, server or personal computer, a speakerphone, etc.).

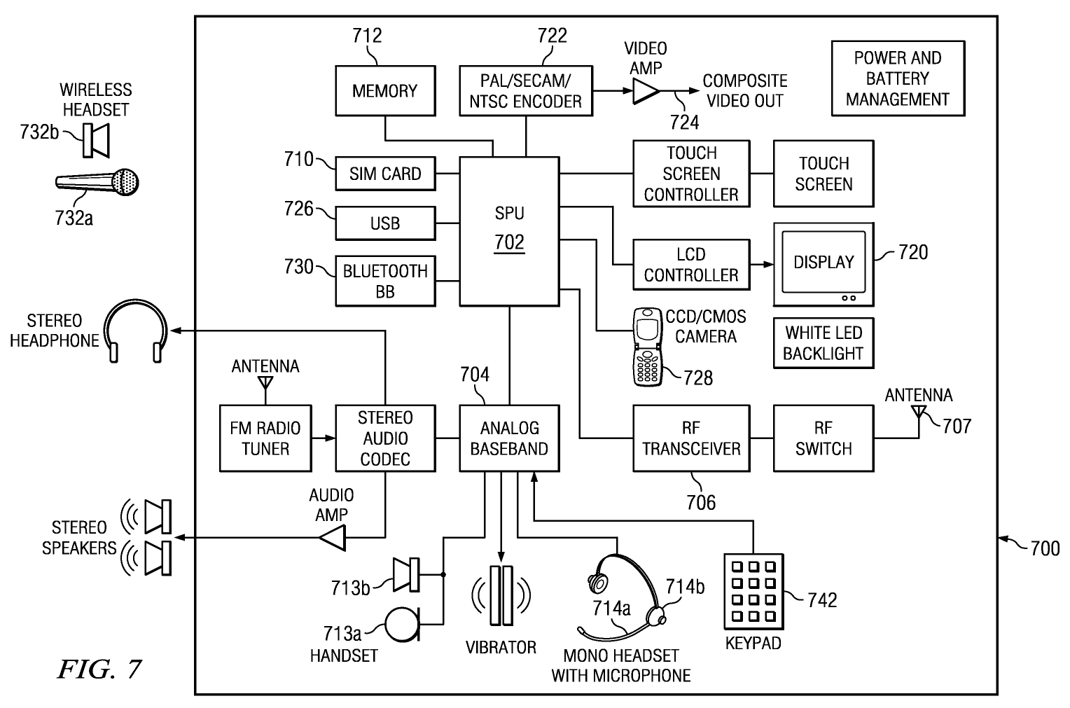

FIG. 7 is a block diagram of an example digital system (e.g., a mobile cellular telephone) (700) that may be configured to perform methods described herein. The digital baseband unit (702) includes a digital signal processing system (DSP) that includes embedded memory and security features. The analog baseband unit (704) receives input audio signals from one or more handset microphones (713a) and sends received audio signals to the handset mono speaker (713b). The analog baseband unit (704) receives input audio signals from one or more microphones (714a) located in a mono headset coupled to the cellular telephone and sends a received audio signal to the mono headset (714b). The digital baseband unit (702) receives input audio signals from one or more microphones (732a) of the wireless headset and sends a received audio signal to the speaker (732b) of the wireless head set. The analog baseband unit (704) and the digital baseband unit (702) may be separate ICs. In many embodiments, the analog baseband unit (704) does not embed a programmable processor core, but performs processing based on configuration of audio paths, filters, gains, etc being setup by software running on the digital baseband unit (702).

The display (720) may also display pictures and video streams received from the network, from a local camera (728), or from other sources such as the USB (726) or the memory (712). The digital baseband unit (702) may also send a video stream to the display (720) that is received from various sources such as the cellular network via the RF transceiver (706) or the camera (726). The digital baseband unit (702) may also send a video stream to an external video display unit via the encoder unit (722) over a composite output terminal (724). The encoder unit (722) may provide encoding according to PAL/SECAM/NTSC video standards.

The digital baseband unit (702) includes functionality to perform the computational operations required for audio encoding and decoding. In one or more embodiments of the invention, the digital baseband unit (702) is configured to perform computational operations of a method for VAD as described herein as part of audio encoding. Two or more input audio inputs may be captured by a configuration of the various available microphones, and these audio inputs may be processed by the method to determine if voice activity is present. For example, two microphones in the handset may be arranged as shown in FIG. 6 to capture a primary audio signal and a secondary audio signal. In the configurations of FIG. 6, one microphone, the primary microphone, is placed at the bottom front center of the cellular telephone in a typical location of a microphone for capturing the voice of a user and the other microphone, the secondary microphone, is placed at different locations along the back and side of the cellular telephone. In another example, a microphone in a headset may be used to capture the primary audio signal and one or more microphones located in the handset may be used to capture secondary audio signals. Software instructions implementing the method may be stored in the memory (712) and executed by the digital baseband unit (702) as part of capturing and/or encoding of audio signals captured by the microphone configuration in use.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims. It is therefore contemplated that the appended claims will cover any such modifications of the embodiments as fall within the true scope and spirit of the invention.

What is claimed is:

1. A method of voice activity detection, the method comprising:
measuring a first signal level in a first sample of a first audio signal from a first audio capture device and a second signal level in a second sample of a second audio signal from a second audio capture device; and
detecting voice activity based on the first signal level, the second signal level, and an activity threshold.

2. The method of claim 1, wherein detecting voice activity further comprises:
computing a difference between the first signal level and the second signal level; and
comparing the difference to the activity threshold to determine whether or not there is voice activity.

3. The method of claim 2, wherein computing a difference comprises computing

|10·log₁₀(P₁)−10·log₁₀(P₂)|

wherein P₁ is the first signal level and P₂ is the second signal level.

4. The method of claim 1, wherein measuring further comprises using smoothing when measuring the first signal level and the second signal level.

5. The method of claim 1, wherein measuring further comprises using first order autoregressive smoothing.

6. The method of claim 1, wherein detecting voice activity further comprises:
comparing the first signal level to a range having lower and upper values determined by the second signal level and first and second thresholds derived from the activity threshold.

7. The method of claim 6, wherein the first threshold is 10^{-0.1·TH} and the second threshold is 10^{0.1·TH} wherein TH is the activity threshold, the lower value is the product of the second signal level and the first threshold, and the upper value is the product of the second signal level and the second threshold.

8. The method of claim 1, wherein detecting voice activity further comprises detecting voice activity based on a hangover counter.

9. The method of claim 1, wherein the first audio capture device and the second audio capture device are comprised in a cellular telephone.

10. A digital system comprising:
a primary microphone configured to capture a primary audio signal;
a secondary microphone configured to capture a secondary audio signal; and
an audio encoder operatively connected to the primary microphone and the secondary microphone to receive the primary audio signal and the secondary audio signal, wherein the audio encoder is configured to detect voice activity by:
measuring a first signal level in a first sample of the primary audio signal and a second signal level in a second sample of the secondary audio signal; and
detecting voice activity based on the first signal level, the second signal level, and an activity threshold.

11. The digital system of claim 10, wherein the digital system is a cellular telephone.

12. The digital system of claim 10, wherein detecting voice activity further comprises:
computing a difference between the first signal level and the second signal level; and
comparing the difference to the activity threshold to determine whether or not there is voice activity.

13. The digital system of claim 12, wherein computing a difference comprises computing
10·log₁₀(P₁)−10·log₁₀(P₂)|

wherein P₁ is the first signal level and P₂ is the second signal level.

14. The digital system of claim 10, wherein detecting voice activity further comprises:
comparing the first signal level to a range having lower and upper values determined by the second signal level and first and second thresholds derived from the activity threshold.

15. The digital system of claim 14, wherein the first threshold is 10^{-0.1·TH} and the second threshold is 10^{0.1·TH}, wherein TH is the activity threshold, the lower value is the product of the second signal level and the first threshold, and the upper value is the product of the second signal level and the second threshold.

16. A digital system comprising:
means for capturing a primary audio signal and a secondary audio signal;
means for measuring a first signal level in a first sample of the primary audio signal and a second signal level in a second sample of the secondary audio signal; and
means for detecting voice activity based on the first signal level, the second signal level, and an activity threshold.

17. The digital system of claim 16, wherein the means for detecting voice activity comprises:
means for computing a difference between the first signal level and the second signal level; and
means for comparing the difference to the activity threshold to determine whether or not there is voice activity.

18. The digital system of claim 17, wherein the means for computing a difference computes the difference as
10·log₁₀(P₁)−10·log₁₀(P₂)|

wherein P₁ is the first signal level and P₂ is the second signal level.

19. The digital system of claim 16, wherein the means for detecting voice activity comprises:
means for comparing the first signal level to a range having lower and upper values determined by the second signal level and first and second thresholds derived from the activity threshold.

20. The digital system of claim 19, wherein the first threshold is 10^{0.1·TH} and the second threshold is 10^{0.1·TH}, wherein TH is the activity threshold, the lower value is the product of the second signal level and the first threshold, and the upper value is the product of the second signal level and the second threshold.
